(19) United States
(12) Patent Application Publication
(10) Pub. No.: US 2006/0158351 A1
(43) Pub. Date: Jul. 20, 2006

(54) Integrated driving information displaying device for a vehicle

(76) Inventors: Horng-Wen Lee, Changhua (TW); Horng-Ming Lee, Changhua (TW)

Correspondence Address: CHARLES E. BAXLEY, ESQ., 90 JOHN STREET, THIRD FLOOR, NEW YORK, NY, 10038, US

(21) Appl. No.: 11/317,555

(22) Filed: Dec. 24, 2005

(30) Foreign Application Priority Data
Dec. 31, 2004 (TW) 093221429

(51) Int. Cl. G08G 1/123; B60Q 1/00; G08B 23/00; G02B 5/08

(52) U.S. Cl. 340/995.1; 340/435; 340/461; 359/844

(57) ABSTRACT

An integrated driving information displaying device for a vehicle comprises an information display unit,. a character memory and a memory card. The information display unit is installed in the rear view mirror housing, in the surface of the rear view mirror housing is formed a slot for insertion of the memory card. After insertion of the memory card, the information display unit will read the character code or symbol code in the memory card, and-the shape of character corresponding to the code will be read by the character memory and will finally be displayed on the information display unit on the rear view mirror. The integrated driving information displaying device can facilitate the driver's drive and reduce the cost for installation of other equipments.

### BACKGROUND OF THE INVENTION

1. Field of the Invention

The present invention relates to a driving information displaying device for a vehicle, and more particularly to a rear view mirror capable of integrating various driving information.

2. Description of the Prior Art

With the development of electronic technology, more and more electronic instruments have been being installed on vehicle, for example, navigation map, digital music player, bluetooth handfree telephone receiver or tire pressure monitoring device. All these instruments need a display for displaying various information, for example, the application of the navigation map needs to display the names of destination for the driver's choice, or display the name of the location where the vehicle is or the name of the nearby street. The application of the digital music player needs to display the name of the song being played or the names of the songs that can be played for the driver's choice. The application of the blue handfree telephone receiver needs to display the calling number, or display the numbers can be called for the driver's choice. The application of the tire pressure monitoring device needs to display all detected pressure values. Therefore, the driver has to face many independent displays after installation of different instruments.

U.S. Pat. No. 5,956,181 “two way mirror with dual functions of rear view mirror and video display” discloses a built-in display for providing alternatively or simultaneously both a conventional reflected image and a video image received from a variety of information sources, so that the aforementioned multi-displays caused trouble can be solved. However, how to make the different information received from the different information sources display on a single display is one of the targets that the researching facilities, the manufacturers and the researchers are perusing, and also is the motivation of the inventor of this invention.

The present invention has arisen to mitigate and/or obviate the afore-described disadvantages.

### SUMMARY OF THE INVENTION

The present invention provides an integrated driving information displaying device for a vehicle, in order to display various information on the rear view mirror for the driver's reference, and to facilitate the driver's drive and reduce the cost for installation of other equipments. That is, utilizing a rear view mirror housing to receive an information display unit, in application, the information unit is partially used as a rear view mirror and partially as a display screen, in this way, various information can be displayed on the rear view mirror during driving.

The more information thing is that the information display unit can display the name of MP3 song, the name of the street nearby the location of the vehicle or provide a list of songs can be played or destinations can be chosen for the driver's choice. Furthermore, it also can display the name of songs being played when receiving radio program, or can receive and display information associated with real-time road condition, achieving the purpose of simultaneously integrating multiple information into a single rear view mirror.

It is noted that the device of the present invention can display the number or the name of the coming call on the rear view mirror, and the driver can decide to answer the coming call, thus reducing the number of using mobile phone during driving, and improving driving safety.

In addition, in the vehicle can be installed a tire pressure monitoring device that is connected to the information display unit, and the condition of the tire pressure can be displayed on the display screen in the rear view mirror housing, improving driving safety.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a block flow chart of an integrated driving information displaying device for a vehicle in accordance with the present invention;

FIG. 2 is an operational and assembly view for showing the integrated driving information displaying device for a vehicle in accordance with the present invention;

FIG. 3 is an illustrated view of a status corresponding to a character memory in accordance with the present invention;

FIG. 4 is an illustrated view of showing the displaying area of the integrated driving information displaying device for a vehicle in accordance with the present invention;

FIG. 5 is an illustrative view in accordance with the present invention of showing that a name of a song is being displayed;

FIG. 6 is an illustrative view in accordance with the present invention of showing that the number and the name of a coming call are being displayed;

FIG. 7 is an illustrative view in accordance with the present invention of showing that a tire pressure warning message is being displayed; and

FIG. 8 is an illustrative view in accordance with the present invention of showing the reversing status of a vehicle.

### DETAILED DESCRIPTION OF THE PREFERRED EMBODIMENTS

The foregoing, and additional objects, features and advantages of the present invention will become apparent from the following detailed description of preferred embodiments thereof, taken in conjunction with the accompanying drawings.

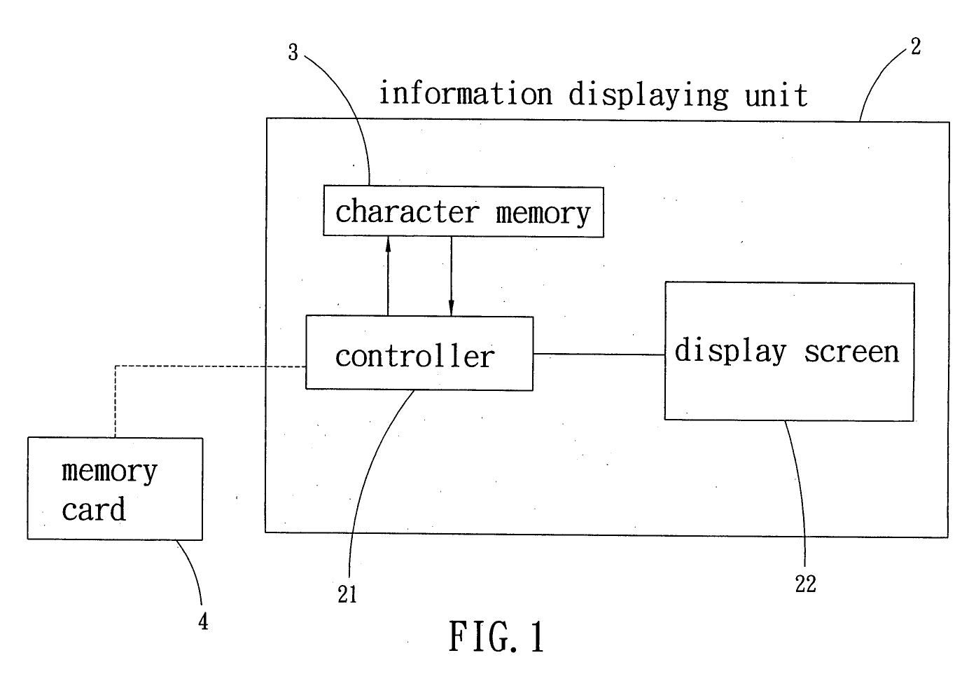

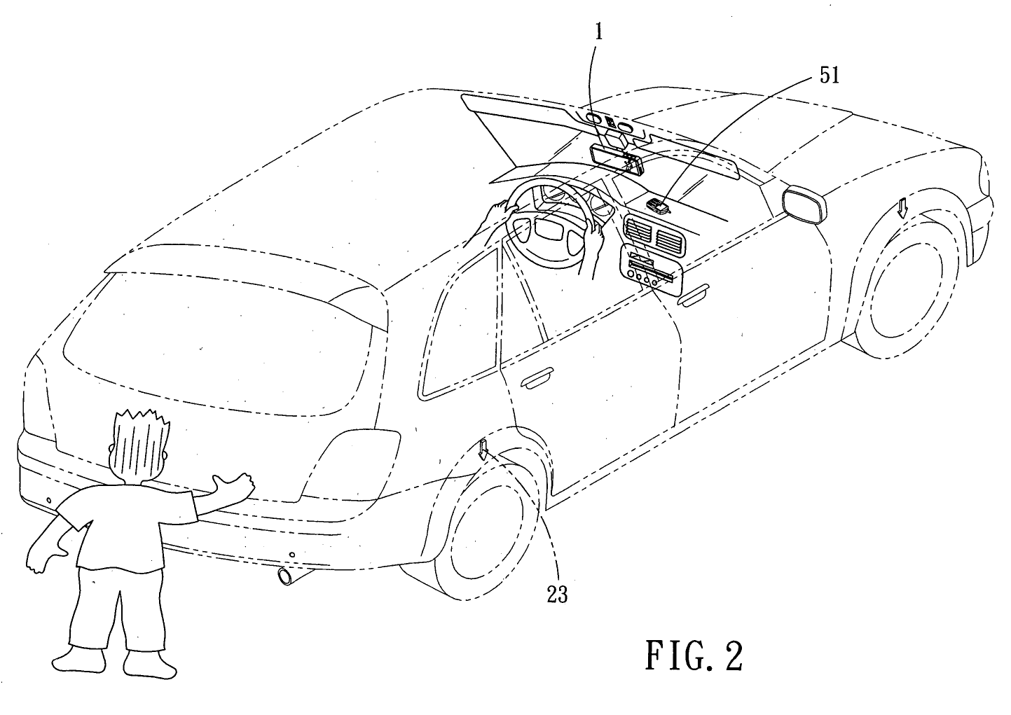

Referring to firstly FIGS. 1 and 2, an integrated driving information displaying device in accordance with the present invention comprises an information displaying unit 2, a character memory 3 and a memory card 1.

The rear view mirror housing 1 is installed in a vehicle.

The information display unit 2 includes a controller 21 and a display screen 22 that are disposed in the rear view mirror housing 1. In the surface of the rear view mirror housing 1 is formed a slot 11, and the display screen 22 is a part of the rear view mirror 22, that is, a part of the display screen 22 serves as a rear view mirror 22 for providing a driver with a reflected view of the area behind the driver both inside and outside the vehicle, and a part of the display screen 22 serves as a display unit. The display screen 22 is a liquid crystal display (LCD) or an organic light emitting diode (OLED) type display.

The character memory 3 is connected to the controller 21 of the information display unit 2, in the character memory 3 are stored the shape of characters of symbols, the shape of characters of symbols are read by the controller 21 firstly and then displayed on the display screen 22.

The memory card 4 is inserted in the slot 11, and in the memory card 4 are stored character code or symbol code (such as ASCII code or BIG 5 code). After the memory card 4 is connected to the controller 21 of the information display unit 2, the controller 21 will read the character code or symbol code (for example, the code can be name of song or street) in the memory card 4, and then read the shape of the corresponding character in the character memory 3, and finally transmit it to the display screen 22. The format of the memory card 4 can be compact flash card, memory stick, multimedia card, smart media card, secure digital card, XD picture card, micro drive disc or any combination of the above formats.

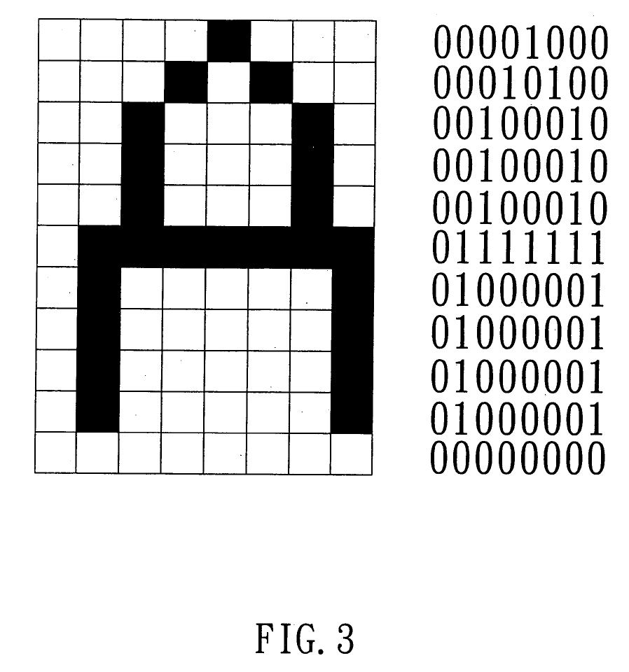

It will be noted that the shape of the character or symbol can be transmitted in a dot matrix fashion to the display screen 22, and the memory for storage of the image data of various characters or symbols is called character memory 3. For example, a method for displaying “A” on the display screen 22 is explained below, 1 represents “light” and 0 means “no light”, the shape of “A” is shown by a binary number (as shown in FIG. 3), then the resultant image is the shape of “A”, and the method of character displaying is called dot matrix character. Furthermore, the dot matrix also can be used to display a symbol, for example, a symbol of “triangle” is shown in the following figure. Besides, a comparatively complicated or a large character can be displayed by the method of combining plural characters or symbols. In addition to the dot matrix method, the commonly used methods include vector character, outline character, etc.

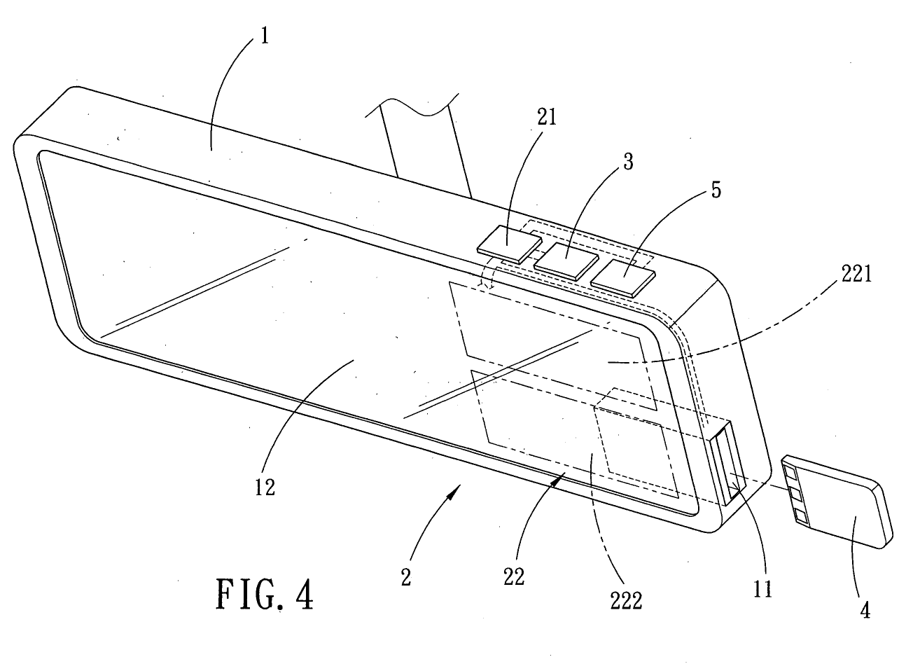

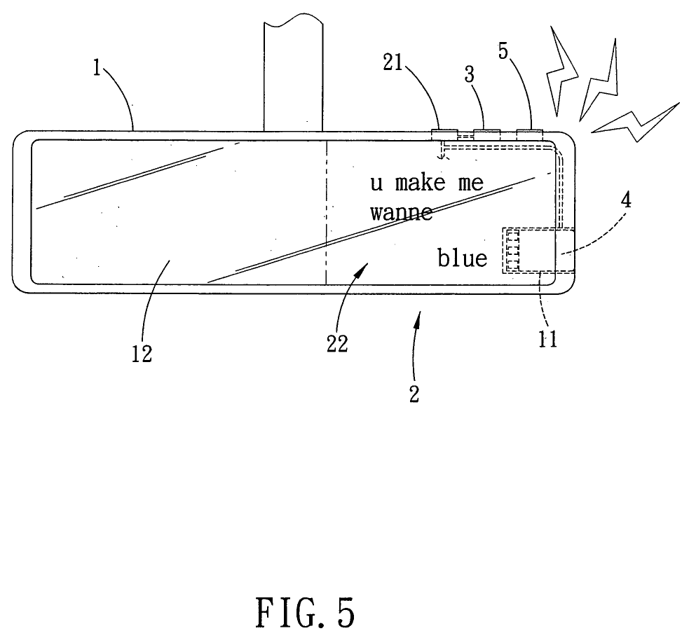

For a better understanding of the embodiment, its operation and function, reference should be.made to FIGS. 4 and 5.

Firstly, if want to display the names of MP3 songs or the electronic map of streets on the display screen 22 of the rear view mirror 12, it has to store the names of MP3 songs or the electronic map of streets in the memory card 4 (such as SD or USB flash card) in MP3 format. After the memory card 4 is inserted in the slot 11 of the rear view mirror housing 1, the controller 21 of the information display unit 2 will read the names of MP3 songs or the electronic map of streets, and then will read the shape of the corresponding character in the character memory 3 and display on the display screen 22. The display screen 22 can be divided into information windows 221 (for example displaying the intersection of ZHONGSHAN road and ZHONGZHENG toad) and information windows 222 (for displaying the name of a song “u make me wane blue”, for example).

Another embodiment of the present invention is also shown on the rear view mirror housing 1 in FIG. 4. The controller 21 of the information display unit 2 is additionally connected to an information receiver 5 installed on the vehicle. After receiving the information code from the information receiver 5, the controller 21 will read the shape of the corresponding character in the character memory 3, and finally display the information on the display screen 22.

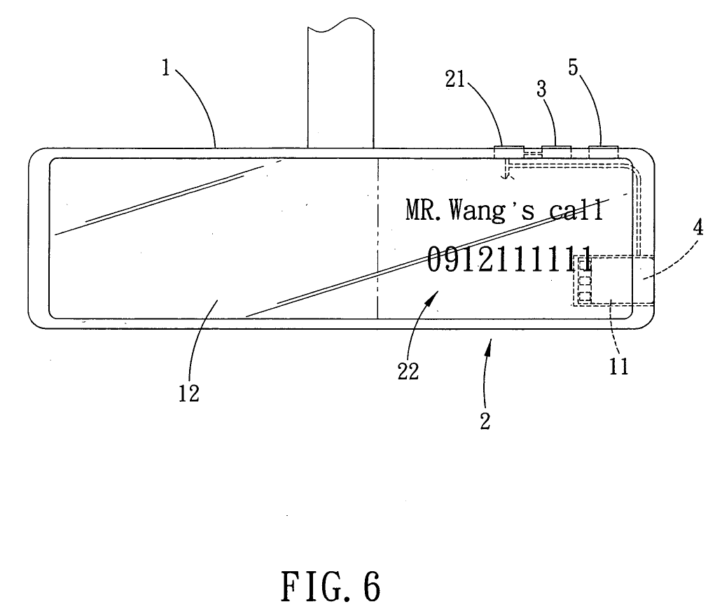

Another embodiment of the present invention is illustrated in FIGS. 2-6, when receiving a signal from a mobile phone 51 and it must display the number or name of the coming call, that is, the information receiver 5 (bluetooth receiving moldO receives the information from mobile phone 51 by means of bluetooth protocol. After the information receiver 5 is connected to the controller 21 of the information display unit 2, and after the controller 21 reads the characters (such as the number or the name of the coming call) in the character memory 3, the information will be displayed on the display screen 22. In this application, the information receiver 5 is also in the form of a bluetooh receiving mode.

In addition, also with reference to FIG. 5, if want to listen to the radio or to know the real-time road condition, the information receiver 5 can receive the digital information (such as digital radio music, name of songs or information about real-time road condition) from the ground radio station or the satellite, and will send it to the controller 21 of the information display unit 2. After the controller 21 reads the characters in the character memory 3, the characters will be displayed on the display screen 22. In this application, the information receiver 5 takes the form of digital information receiver.

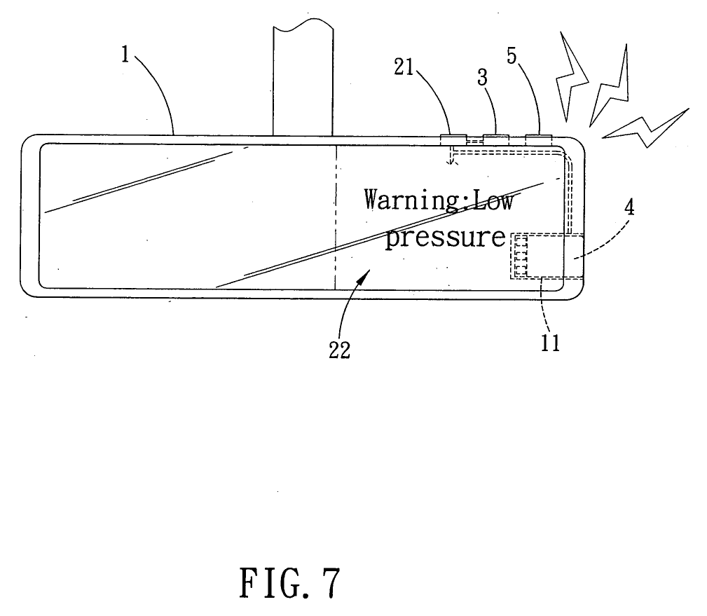

Finally, referring simultaneously to FIGS. 2 and FIG. 7, after the pressure monitoring device 23 installed in the tire measures the pressure of the tire, the detected pressure will be transmitted to the information receiver 5 of the information display unit 2 by means of magnetic wave. Then the information receiver 5 will transmit the data to the controller 21. The controller 21 will read the corresponding characters in the character memory 3, then will transmit and display the read characters on the display screen 22. In this application, the information receiver 5 is the receiver for receiving the information from the pressure monitoring device 23.

If a vehicle is equipped with a plurality of information receivers 5, it only needs to transmit the information received by the information receivers 5 to the controller 21 of the information display unit 2, and after reading the corresponding characters in the character memory 3, the read characters will be displayed at different positions on the display screen 22.

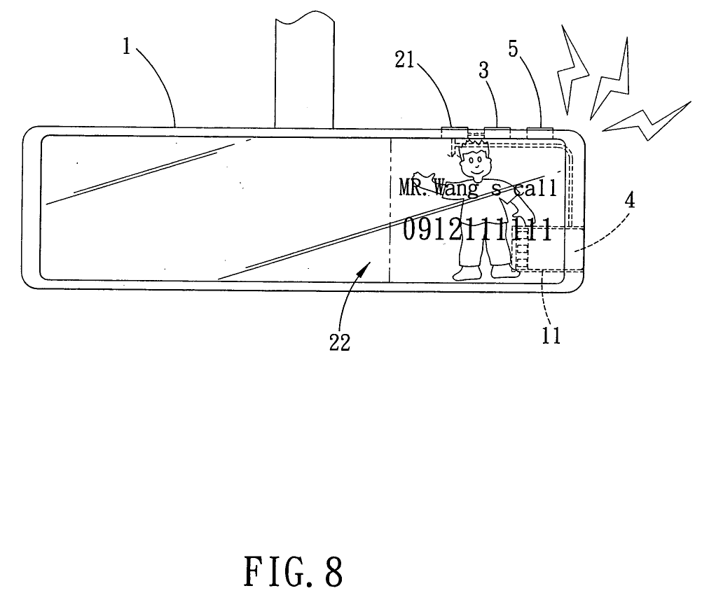

In addition, with reference to FIGS. 2 and 8, the integrated driving information displaying device for a vehicle can utilize the reversing function described by the U.S. Pat. No. 5,956,181 “two way mirror with dual functions of rear view mirror and video display”, using the controller 21 to place the images of the characters or symbols in the character memory 3 over the image of the area behind the vehicle, and then display it on the display screen 22.

Therefore, the integrated driving information displaying device for a vehicle in accordance with the present invention can integrate the signals of the plural information receivers 5 into a single display screen 22, it will not affect the operation of the original rear view mirror 12, but also can make it convenient for the driver to use different instruments and can reduce the cost for installation of other equipments.

While we have shown and described various embodiments in accordance with the present invention, it should be clear to those skilled in the art that further embodiments may be made without departing from the scope of the present invention.

What is claimed is:

1. An integrated driving information displaying device for a vehicle comprising:
a rear view mirror housing defined with a slot;
a memory card stored with character codes or symbol codes and inserted in the slot of the rear view mirror housing;
an information display uriit including a controller and a display screen, installed in the rear view mirror housing, the controller of the information display unit is connected to the memory card, the character codes or symbol codes in the memory card are read by the controller and then displayed on the display screen; and
a character memory stored with shapes corresponding to the character codes or symbol codes, connected to the controller of the information display unit, the controller reads the shapes corresponding to the character codes or symbol codes in the character memory, and then the display screen of the information display unit displays the shapes corresponding to the character codes or symbol codes.

2. The integrated driving information displaying device for a vehicle as claimed in claim 1, wherein the character memory is installed in the rear view mirror housing.

3. The integrated driving information displaying device for a vehicle as claimed in claim 1, wherein the character memory is installed in the memory card.

4. The integrated driving information displaying device for a vehicle as claimed in claim 1, wherein the memory card takes the forms of compact flash, memory stick, multimedia card, smart media, secured digital card, XD picture card, micro drive card or the combination of at least the above two forms.

5. The integrated driving information displaying device for a vehicle as claimed in claim 1, wherein displaying dots on the display screen of the information display unit are arranged in the form of dot matrix.

6. The integrated driving information displaying device for a vehicle as claimed in claim 1, wherein the display screen of the information display unit is a liquid crystal display or an organic light emitting diode display.

7. The integrated driving information displaying device for a vehicle as claimed in claim 1, wherein the information display unit further includes another information receiver, after a controller of an information display unit of this another information receiver receives the characters or symbols in the information receiver and reads the shapes of the shapes corresponding to the character codes or symbol codes in the character memory, the information will be displayed on the display screen.

8. The integrated driving information displaying device for a vehicle as claimed in claim 7, wherein the information receiver is a bluetooh receiver using bluetooh protocol.

9. The integrated driving information displaying device for a vehicle as claimed in claim 7, wherein the information receiver receives digital information from ground radio station or satellite.

10. The integrated driving information displaying device for a vehicle as claimed in claim 7, wherein the information receiver is connected to a magnetic wave signal of a tire pressure monitoring device and serves to receive the magnetic wave signal.
